(19) United States
(12) Patent Application Publication
(10) Pub. No.: US 2016/0202963 A1
(43) Pub. Date: Jul. 14, 2016

(54) SOFTWARE DEPLOYMENT OVER A NETWORK

(71) Applicant: Microsoft Technology Licensing, LLC, Redmond, WA (US)

(72) Inventors: Jianhui Xie, Palo Alto, CA (US); Ferry Susanto, Bellevue, WA (US); Steven F. Goddard, Seattle, WA (US); Michael L. Liptack, Monroe, WA (US)

(21) Appl. No.: 14/995,140

(22) Filed: Jan. 13, 2016

Related U.S. Application Data
(63) Continuation of application No. 12/406,043, filed on Mar. 17, 2009.

(51) Int. Cl. G06F 9/445; G06F 17/30; H04L 29/08

(52) U.S. Cl. CPC G06F 8/61; H04L 67/34; G06F 17/30864

(57) ABSTRACT

Devices in a network environment may have a local client application that may periodically update software components on a local device and may configure user access and other parameters to the software component for individual users. The client application may operate by querying a domain server and may receive a description of available software components. After identifying a component to install, the client application may download the component from a data store and install the component, then configure individual user access to the component.

### CROSS-REFERENCE TO RELATED APPLICATION(S)

This application is a continuation of U.S. patent application Ser. No. 12/406,043, filed Mar. 17, 2009, entitled “SOFTWARE DEPLOYMENT OVER A NETWORK,” (Atty. Dkt. No. 326496.03. The entirety of this afore-mentioned application is incorporated herein by reference.

### BACKGROUND

Managing software applications in a corporate or enterprise environment can be very cumbersome. In a corporation or enterprise, several hundred or even thousands of personal computers and other devices may each have multiple applications installed.

Many devices, such as personal computers, have a login mechanism that may permit or deny access to the device. The login mechanism may also establish different sets of permissions for different users. Some users may have full access to some resources, while other users may have limited or no access to the same resources.

In a corporate or enterprise network, several users may have access to a device, but the users may have different roles in the corporation and may have different access to applications.

For example, a computer used in a shipping department may have a financial application operating on the computer. The staff responsible for preparing shipments for transit may access the computer and may have their access to the financial application limited to being able to process outbound shipments. An accountant or manager may have access to the same computer but may be able to access additional functions or sensitive financial data within the financial application.

### SUMMARY

Devices in a network environment may have a local client application that may periodically update software components on a local device and may configure user access and other parameters to the software component for individual users. The client application may operate by querying a domain server and may receive a description of available software components. After identifying a component to install, the client application may download the component from a data store and install the component, then configure individual user access to the component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with remote deployment of software.

FIG. 2 is a diagram illustration of an embodiment showing an architecture for a domain database.

FIG. 3 is a timeline illustration of an embodiment showing a method for updating a client device.

### DETAILED DESCRIPTION

Applications may be deployed to client devices in a network environment and configured differently for different users of the client devices. A domain server may have a domain database that may contain user information, information about the client devices, and software components that may be installed on the client devices. The client devices may have a service that queries the domain server and receive descriptions of software components. The service may install the software components and configure each one for each user of the device.

The domain server may be organized with groups, roles, or other mechanisms that may make assigning software components to individual devices easier. One embodiment may be a role based access control mechanism.

The client service may periodically request a current status of the installed software for the device. Such requests may be made any time the client device is operating and able to communicate with the domain server, and may not be event driven. An event driven request may occur when a client device is started, or when a user logs on or off the domain, for example.

The periodic queries may allow changes to the software configuration of a client device to be propagated through a network quickly. Some software changes, such as security settings for an anti-malware application, or a new version of an anti-malware application, may be dispersed to client devices without any local user interaction. For example, an employee may logon to a device and may have locked the device from other people's access. While the device is locked, updates to the software on the device may still be implemented.

Throughout this specification and claims, references may be made to local permissions and domain permissions. “Local” refers to a specific device, which is a client device. A local service is a service that operates on the local device. A user has local permissions that allow access to the local service. “Domain” refers to things that relate to the domain or network as a whole. A user that has domain privileges will be able to access services available to the domain, regardless of the client device the user is using. Domain privileges are agnostic of the client devices, and client privileges are agnostic of the domain services.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

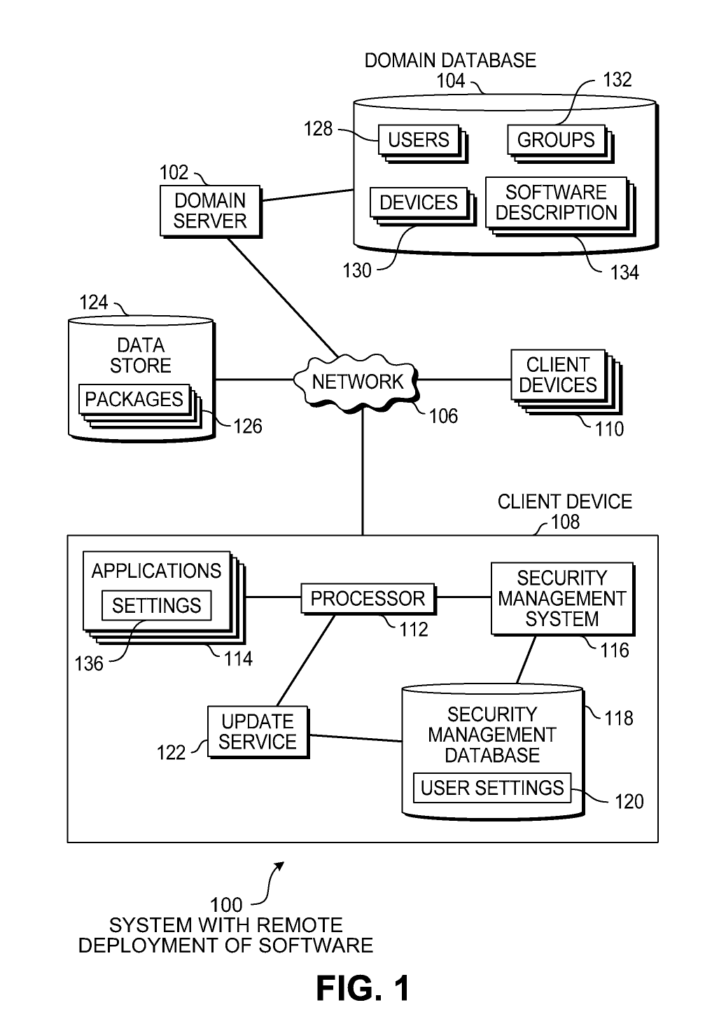

FIG. 1 is a diagram of an embodiment 100 showing a system with remote deployment for software. Embodiment 100 is a simplified example of a system by which a domain server may cause a client device to download and install local software.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a network environment that may be typical of a small business or enterprise, and where the software and software configuration of multiple client devices may be managed from a central location. In many such embodiments, a domain server 102 may provide many different services to various clients.

The domain server 102 may manage many different aspects of the network. In many embodiments, the domain server 102 may manage a domain database 104 which may contain information about many different objects associated with the network. Some of the objects may include users 128, client devices 130, and various services available on the network.

For a user, the domain database 104 may contain login information and other descriptors of the user, such as email addresses, aliases, as well as passwords and credentials for the user. When a user attempts to login to a client device, the client device may communicate with the domain server 102 to verify the user's credentials. Such a system may allow a user to login to many different client devices on the network without having to have local permissions to the device. Such a system may also enable an administrator to deny access to a former employee that has left the organization, as well as add new employees in a simple manner.

The domain database 104 may contain information about client devices 130. The information about the client devices 130 may contain configuration information about the devices. Some of the configuration information may be static information such as a device type, processor capabilities, and other hardware parameters that are unlikely to change often, if ever. Other information may be dynamic information that may be changed from time to time and may be used by the client device to configure itself.

An example of the device information may be information about the software components on the client device. The domain database 104 may contain descriptions 134 for devices 130 that contain listings of the software components that should be present on a client device plus settings for configuring those components.

The domain server 102 may be a Lightweight Directory Access Protocol (LDAP) server. LDAP is a protocol by which client devices may send an operation request to a server and receive a response from the server. The LDAP server may maintain a domain database 104 that may contain information about users and devices on the network 106. Typically, an LDAP server may maintain user permission settings and other attributes about the users, and those settings may be arranged in a directory structure. An LDAP server may build, modify, and search the directory structure using the commands from a client device or from an application running on the domain server 102.

LDAP is one mechanism by which a network may be managed through a server. Other embodiments may use X.500, Directory Access Protocol, Domain Name System, and other directory services. Many embodiments may be based on LDAP technologies and may be extensions to a standardized implementation of LDAP.

An example configuration of a domain database is illustrated in embodiment 200 presented later in this specification.

The client devices 108 and 110 may have a service that periodically queries the domain database 104 and request an update of the software descriptions 134 that apply to the device. The service on the client device may perform any installation or removal of a software component, and may configure the component.

In many embodiments, a user on a network may have two distinctly separate sets of permissions. The first set of permissions may be a domain level set of permissions, which may define the user's access to various resources on the network. The domain level set of permissions may be agnostic of the device used to access those resources, meaning that the user may login to different devices and may have the same access to domain level resources.

The second set of permissions may be a local level set of permissions. The local level set of permissions may allow or deny access to local resources. For example, a computer may be assigned to an employee and may be configured so that the employee may have administrator privileges on the local device. Administrator privileges may allow the employee to install and configure software on the device. A local user account on the device may be configured with a directory in which the employee may store personal information on the device. Typically, other users of the device may not have access to another user's personal directory, and other users may not have administrator privileges.

The local set of privileges may be distinct from the domain level privileges. An administrator on a local device may not have administrator privileges for domain level resources, and an administrator of domain resources may not have any privileges for local level resources.

In many cases, individual users on a local device may have different access privileges to local level software resources on a device. For example, an accountant may have access to a financial application on a local device, but other users of the same local device may not have any access to the same application.

In some cases, one user may have access to the full functionality of an application, but another user may have more limited access. In the example above, an accountant may have unrestricted access to a financial application on a local device, while a shipping clerk may have a restricted access to the same application. The restricted access may permit access only for shipping and receiving items but not for accessing company financial data that may be sensitive.

There are many different reasons why different users may have different local permissions. In the example above of the accountant, the job functions or roles of the users may be different. Another reason may be software or content licensing. For example, a software application may be licensed on a per-user basis or a content license may limit access to certain data to specific users. For each user that has access to an application or content, the user may be given read permission or read write permissions. For users that do not have permission, a user may be given no permission or some other restrictive permission.

In a small network, a single domain server 102 may be used to manage several client devices. In a typical business environment, a single domain server 102 may manage up to 25 or so devices. Larger embodiments may use multiple domain servers 102. Some embodiments with multiple domain servers may use a replication technology to replicate a domain database 104 or portions of the domain database 104 across different servers. Such embodiments may propagate changes to a domain database 104 across multiple servers, and those changes may be then propagated to client devices.

The network 106 may be any type of network used for communication. A typical embodiment may be a local area network connected using Ethernet. Other embodiments may be geographically dispersed. Some embodiments may be connected using wireless technologies or a combination of multiple connection technologies.

A client device 108 may represent any type of device that may connect to and be managed by a domain server 102. In a typical business environment, the client device 108 may be a desktop or laptop computer, a mobile device such as a mobile telephone or personal digital assistant, or any other device. In an industrial environment, the client device 108 may be an industrial process controller, a portable handheld scanning device, a dispatch computer mounted to a fork lift truck, or some other device.

The client device 108 is illustrated as a simplified embodiment of a typical client device. The client device 108 may have a processor 112 that may execute software components. The software components may be operating systems, operating system components, applications 114, and other executable programs.

The client devices 108 may have a processor 110 on which may be running a security management system 112. The security management system 112 may permit or deny certain operations, functions, or resources to individual users, based on entries stored in a security management database 118.

The security management system 112 may be an operating system level service that may allow a user to logon to the client device 108 and may set the user's permissions at the login operation. In some embodiments, the security management system 112 may deny a user access to the client device 108 if the user does not present credentials that match an entry in the security management database 118.

In some embodiments, the security management database 118 may contain passwords, encryption keys, or other credentials for each user of the client device 108. Such credentials may be stored using hashes or other technology so that the credentials may not be easily accessed. During a login attempt by a user, the user's password or other credential may be hashed and compared to the stored value in the security management database 118. Based on a successful match, the user may be allowed to continue a login process and may have certain local resources and local capabilities set for the user's session.

In some embodiments, a security management system 112 may perform a query to the domain server 102 during the login process to retrieve information about the user credentials. In some embodiments, the comparison between the user's credentials and stored credentials may be performed by a domain server 102, while in other embodiments, such comparisons may be performed by the security management system 112 on the client device 108.

During a login process, a user may be granted a set of domain permissions and a set of local permissions. The domain permissions may allow or deny access to resources available over the network 106, and the local permissions may allow or deny access to local resources available on the client device 108. The settings for individual users may be stored in user settings 120 in the security management database 118

Some client devices 108 may have two different login mechanisms for local users and domain users. For example, a local user may be limited to those users who have a local entry in the security management database 118. In many cases, a local user may be permitted access to local resources, but may be denied access to domain resources.

Continuing with the example, a domain user may attempt a login to a client device 108 using domain credentials. In such a case, the security management system 112 may attempt to find the user's credentials from the local security management database 118 and, if the credentials are not found, may query the domain server 102 to determine if the user's credentials may be found in the domain database 104. If the domain database 104 contains the user's credentials, the credentials may be transmitted to the client device 108 and the user may be permitted to logon to the client device 108.

Both local and domain permissions may be defined in access control lists for users and devices. An access control list may contain a list of permissions attached to an object and may specify who or what is allowed access to the object and what operations are allowed to be performed on the objects. Embodiments that use access control lists can be classified into discretionary and mandatory. A discretionary access control system typically allows the owner of an object to fully control access to the object, including altering the access control list to grant access to other objects. A mandatory access control list may enforce system-wide restrictions that override permissions in an access control list.

In some embodiments, an access control list may be a table or other data structure that may contain entries that specify individual user or group rights to specific system objects, such as a program, process, or a file. Some embodiments may use a term of access control entries for such access control lists. The privileges or permissions may determine specific access rights, such as whether a user can read from, write to, or execute an object. Some embodiments may control whether a user or group of users may alter an access control list of an object.

Some embodiments may use a role based access control mechanism. In some embodiments, role based access control may be referred to as role based security. In role based access control, roles may be created for various functions, such as a job function within a company or other enterprise. The permissions to perform certain operations may be assigned to specific roles. Users may be assigned one or more roles, and through the role assignments, the user may receive permissions to perform certain functions or access certain resources.

In a role based access control mechanism, groups may be defined that align with the roles within the role based access control. Examples of various groups may be described in embodiment 200 later in this specification.

A set of local permissions may permit or deny access to local resources. Examples of local resources include local file directories, local peripherals such as printers and scanners, and various services that may operate on the client device. For example a user may be permitted the following types of access to a file system: full control, traverse folder, execute file, list folder, read data, read attributes, read extended attributes, create files, write data, create folders, append data to folders, write attributes, change permissions, take ownership, and other permissions. In another example, a user may be permitted access to a printer for printing, modifying the printer setup, using specific functions of the printer such as color printing, and allowing or disallowing access to the printer for other users or services. Many other examples may exist based on the client device 108 and the capabilities of the client device 108.

In the domain database 104, there may be definitions for users 128, devices 130, groups 132, and software descriptions 134. User definitions may have user specific attributes, such as login name, passwords, and other credentials. Groups 132 may define the roles described above and may operate as a template for permissions that may be applied to members of the group. In a simple example, a member of a general user group may have access for using a resource, but may not have access for modifying the resource that a member of an administrator group may have.

The domain database 104 may have local software settings for users 128 for each device 130. The local software settings for users 128 may be separate sets of permissions for individual users for software on each device. In many embodiments, the sets of permissions may be defined by assigning a user to a group or role for each device. For example, a user may be assigned to an administrator group for a software application, which may allow the user full access to install and modify the application. Another user may be assigned to a general user group and may be able to use the application but may not be permitted to change the application configuration. A third user may be prohibited from accessing the application entirely.

An update service 122 may be a service that operates on the client device 108 and may periodically update the local security management database 118 with the user settings 120 for various software components. In a typical embodiment, the update service 122 may send a query to the domain database 104 and may download and store changes in the local security management database 118.

The combination of the local permissions for users 128 in the domain database 104 and the update service 122 may allow remote management of local user permissions for individual software components on individual devices. An update may be made to the software component settings for users 128 in the domain database 104, and the update may be propagated to the client device 108 by the periodic query mechanism of the update service 122.

In many embodiments, the update service 122 may perform an update while one user is logged into the device. When the update service 122 performs an update, the software component permission settings for the currently logged in user as well as many other users may be updated.

In one use scenario, an update to an anti-malware software application may be deployed across a network. The update may be a simple change to a configuration setting or database, or the update may be implemented in an executable package that removes the previous version of the application and installs a new version. An administrator may update the appropriate entries in the domain database 104 that may define the proper version of the application and the other configuration parameters for the anti-malware application. The update service 122 may query the domain server 102 and may receive a description of the desired software and configuration for the client device 108. The update service 122 may identify any changes that are to be made to the applications 114 and any application settings 136 and may implement the changes.

In some cases, the update service 122 may communicate with a data store 124 and may download an installation package 126. The data store 124 may be a data store available on a local area network, or in some cases, the data store 124 may be available over a wide area network such as the Internet.

When the update service 122 receives the installation package 126, the update service 122 may perform a change to the client device 108. In some embodiments, the installation package may be a script, executable file, installation file, or some other form of executable package that may perform an installation or update. The update service 122 may perform its actions while a user is logged into the client device 108. In some embodiments, the update service 122 may periodically query the domain server 102 on a regular basis. Some embodiments may perform queries every few minutes, while other embodiments may perform queries every few hours or even every several days. The time for propagating changes across the network may be proportional to the length of delay between periodic queries.

In another use scenario, an employee in a company may be promoted or may change job functions. In the new job function, the employee may have a different role in the company and may use different software applications or have access to different data. An administrator may change the domain database 104 to permit the employee access to specific applications or data. For example, the domain database 104 may be updated to allow the employee to have access to a specific local software application on every device that has the software application.

Each update service 122 on client devices 108 and 110 may periodically query the domain server 102 and receive an updated set of software descriptions 134 for the individual client device. The update service 122 may change the user settings 120 in a local security management database 118 to permit the user access to the designated local application or data. After the change is propagated, the user may gain access to the application or data on the updated client devices, but other user's access on those client devices to the local application or data may be unaffected.

In some embodiments, the update service 122 may receive periodic transmissions from the domain server 102 and may update the security management database 118 using the information received from the domain server 102. In such an embodiment, updates or changes to the local permissions for users 128 may be pushed to the client devices 108 and 110. In an embodiment where the update service 122 requests data from the domain server 102, the client devices 108 and 110 may pull date from the domain server 102.

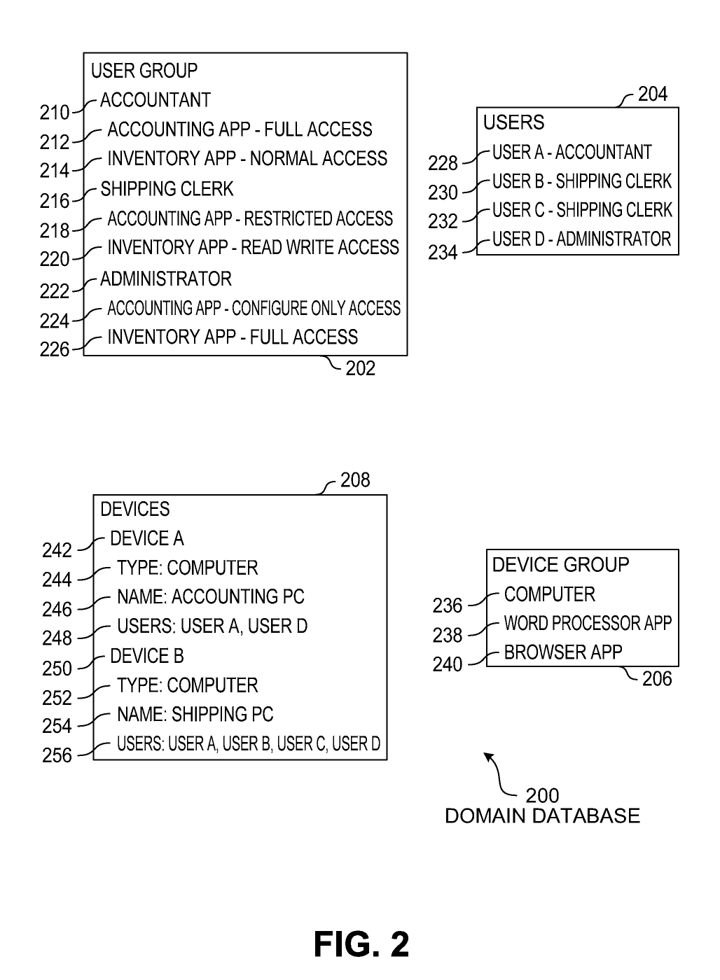

FIG. 2 is a diagram of an embodiment 200 showing a domain database. Embodiment 200 is a simplified illustration of a subset of data that may be in a domain database, such as the domain database 104. Embodiment 200 is merely one example of how a domain database 104 may be configured using groups to define software settings for user groups, and then assigning users to groups for various client devices.

The domain database of embodiment 200 may have separate entries for user groups 202, users 204, device groups 206 and devices 208.

The user groups 202 may define different roles a user may be assigned and may define how specific applications may be configured for users who are members of the group. In many embodiments, a group may have many several to hundreds of individual settings.

Entries within the user groups 202 may be defined for roles that a user may have. Within each role, software component configurations may be defined for the members of the role. When a user is assigned to a group, and the user is assigned to a device as a member of the group, the software component configurations defined for the role may be assigned to the device and for those users of the device.

Using various groups, a domain database may be used to very flexibly manage the software configurations for individual users of individual devices. The power and flexibility of role based or group based configuration system may be used to define software configurations in many different ways. The example of embodiment 200 is a very simplified example of how such system may be configured and used. Other embodiments may have different groupings and other mechanisms to determine software configurations for individual devices, and configurations or settings for individual users of those devices.

In a very simplified mechanism, each device may have a list of software applications, and individual users may have different settings defined. For a device with ten users and ten applications, there may be 100 entries. Such lists may be suitable for small embodiments with just a few client devices, but may become unwieldy when used to manage many tens, hundreds, or thousands of devices.

In the user group 202, an entry 210 may define the software that may be assigned to a member of the group. Under the entry 210, there may be an entry 212 for an accounting application. Within the entry 212, the accounting application may have settings defined for full access.

The settings within the entry 212 may contain entries for settings used by the application to define the available functions for the member of the group. For example, an application may have a configuration mechanism, such as a configuration file, that may have certain settings that change the functionality of the application.

An example may be a link in a favorites list for a browser. Within the entry 212, a web address may be defined that may be added to a user's web browser favorites list. The web address may direct the user to a special website that may access a feature of the financial application.

The settings within the entry 212 may contain operating system entries that may allow and control access to the application or its data using operating system controls. An example may be to set a user's access to a database as read only. Such an access privilege may be an operating system level access setting that is defined in entry 212 and enforced by the operating system on the client device.

Similar to entry 214, an inventory application may be configured for normal access.

An entry 216 may be defined for a shipping clerk. Within entry 216, a shipping clerk may have restricted access to the financial application in entry 218 and read write access to the inventory application in entry 220.

An entry 222 may be defined for an administrator. Within entry 222, an administrator may have configure-only access to the accounting application in entry 224, and full access to the inventory application in entry 226. The configure-only access in entry 224 may allow the administrator to configure the application but may not allow the administrator to access any sensitive financial information.

The entries for applications, such as entries 212 and 214 may contain individual settings for applications. The settings for an application may be the software descriptions 134 as described in embodiment 100.

The users 204 may be defined by entry 228, where User A is a member of the accountant group. In entries 230 and 232, Users B and C are respective members of the shipping clerk group. Entry 234 defines User D as an administrator.

Because User A is a member of the accountant group, when User A is assigned to a device, the settings for the accountant group may be applied to the device, as will be shown below.

In some embodiments, a user may be assigned to two or more groups. In such a case, the parameters associated with all of the roles may be aggregated. For example, a user may be members of both the accountant and administrator groups.

The device group 206 may define applications that may be assigned to a device and may be common to all users of the device. In entry 236, a computer is defined to have a word processor application in entry 238 and a browser application in entry 240.

The device group 206 may be a mechanism for distributing applications to devices where the applications or other software components do not have specific settings for specific users. For example, if an administrator wanted to deploy an anti-malware program, the administrator may add the anti-malware program as an entry under the computer entry 236. When a client device requested a description of the software components for that device, the anti-malware program may be included in the list.

In the devices 208, entries may be defined for different devices. For example, Device A in entry 242 may include an entry 244 for the type of device as a computer. Because of the entry 244, any software components defined for a device having the type of computer, the entries 238 and 240 may define applications that may be applied to Device A. The entry 244 may be said to inherit the features of entry 236.

Entry 246 may define the name of Device A as “Accounting PC”, and entry 248 may define the users for Device A as User A and User D.

Because User A is an accountant in entry 228, Device A may inherit the features defined for accountants in entry 210. Similarly, User D is an administrator as defined in entry 234 and Device A may inherit the features defined for administrators in entry 222.

When a software component is defined on a user specific level, the client device may configure that software component differently for one user than another. For example, the accounting application on Device A may be configured so that User A has full access to the application but User B has configure-only access. Other users to Device A may have access to the word processor application and browser, as defined in entry 236, but may not have any access to the financial application or inventory application. Because the word processor application and browser application are configured for all users, Users A and B would also have access to those applications.

Entry 250 may define the characteristics of Device B. In entry 252, the device type may be computer and in entry 254, the name may be “Shipping PC”. Entry 256 defines the users for Device B as Users A, B, C, and D.

In the example of Device B, the computer may be configured with a word processor application and browser application from entry 236, where those applications may be permitted for all users. The accounting application may be installed on Device B with full access granted to User A, restricted access granted to Users B and C, and configure-only access to User D. The inventory application may be installed on Device B with normal access granted to User A, read write access granted to Users B and C, and full access granted to User D.

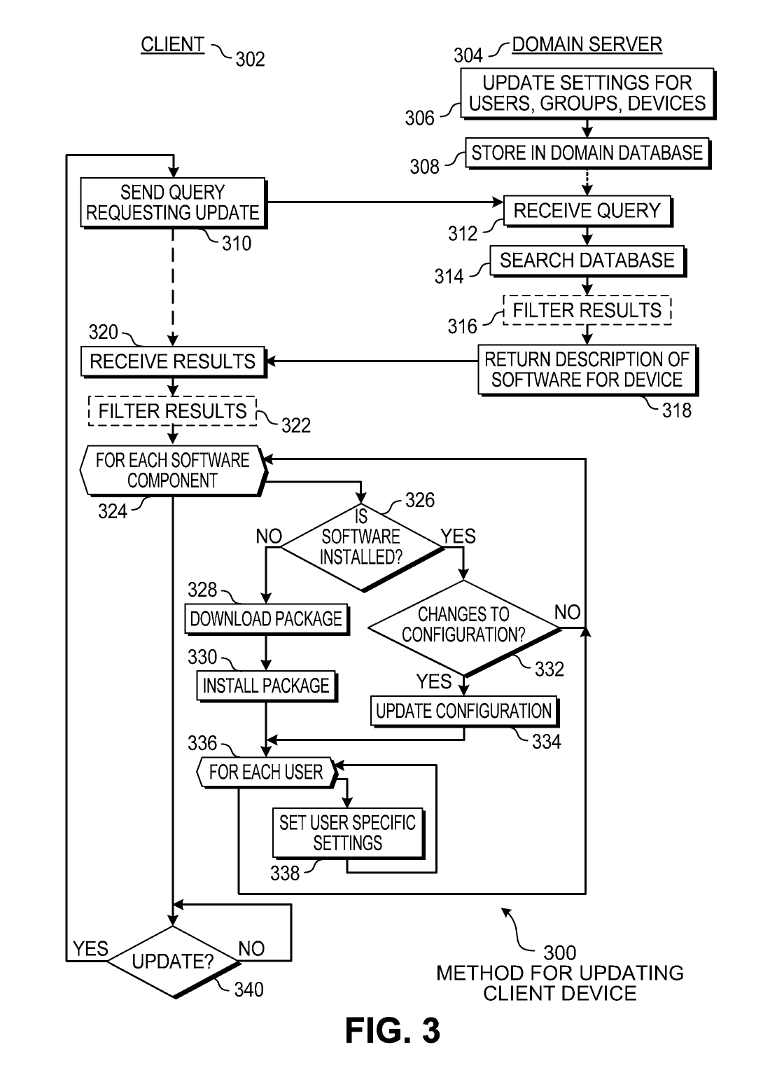

FIG. 3 is a timeline illustration of an embodiment 300 showing a sequence updating a client device. Embodiment 300 is a simplified example of a method where a client 302 may pull configuration information from a domain server 304. The actions of the client 302, illustrated on the left hand side of the figure, may correspond to the actions of a client device 108 and specifically the update service 122 of the client device 108 in embodiment 100. The actions of the domain server 304 may correspond with the actions performed by a domain server 102 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is one example of sequences and handshaking that may be performed by a client 302 and server 304 during an update sequence. Embodiment 300 illustrates a method by which a client 302 may query the domain server 304, receive definitions of software components, and may download and install the software components. The client 302 may modify the per-user settings based on the definitions as well.

In block 306, an update is created to a local permission setting for a specific user on a specific device and in block 308, the update is stored in a domain database. In some cases, an update to the database may cause a new record to be created or a new entry within a record to be created. Because each embodiment may have different types of databases, each having a different configuration, the precise method for managing the database may vary from embodiment to embodiment.

In many cases, some type of user interface may be used to make the changes in block 406. Many servers may have a local console or remote access console through which an administrator may monitor and update many different parameters about the server. In such a case, the server may have a graphical user interface, scripting interface, command line interface, or some other mechanism by which an administrator may select the desired settings and cause the settings to be entered into the database in block 408. In many such embodiments, the process of creating and storing updates may be partially or fully automated using scripting or other executable languages.

In block 310, the client 302 may send a query to the domain server 304 requesting updates.

The query may be received in block 312 by the domain server 304. Based on the query, the domain server 304 may search the database in block 314. In searching the database in block 314, the domain server 304 may gather all of the software settings that may be applicable to the client 302. In some embodiments, the domain server 304 may filter the results in block 316.

In some embodiments, the request transmitted in block 310 may be for a subset of the entire set of descriptions of software components based on some filter parameters. The filter operation of block 316 may filter the results of the search in block 314 to filter the set of descriptions to meet the filter parameters.

In block 318, the description of the software applicable to the client may be returned by the domain server 304. In many embodiments, the description may be a useful format, such as XML, that may allow rapid searching or have other benefits.

In block 320, the client 302 may receive the description and may filter the results in block 322. Some embodiments may perform a filtering operation on the client 302 that was described in block 316.

For each software component in block 324, the following process may be performed. If the software component is not already installed in block 326, the package describing the software component may be downloaded in block 328 and installed in block 330.

Different embodiments may have different mechanisms for downloading and installing a software component. In some embodiments, the description received in block 320 may have sufficient information for an update service to perform the change. For example, a registry key setting used by an operating system may be defined in the description received in block 320 and implemented by an update service. In some embodiments, the descriptions received in block 320 may include scripts or other executable code that may implement the setting or software component.

In some embodiments, the description in block 320 may contain an address, Uniform Resource Locator (URL), name, or other indicator by which an update service may locate and download an installation package. In some embodiments, an installation package may be located on a data store accessible on a local area network. Some such embodiments may have a data store attached to or operated by a domain server.

The installation package may be any type of information that may be used to create the software component. In some cases, an installation application may be used to process an installation package. The installation application may create directories, unpack compressed files, update registry keys, configure configuration files, and perform many installation tasks. In some cases, the installation package may contain scripts or other executable files.

If the software is installed in block 326, and there are no changes to the configuration in the description in block 332, the process may return to block 324 to process another software component.

If the software is installed in block 326 and changes are to be made in block 332, the configuration of the software component may be updated in block 334.

After the software is installed in block 330 or configuration changed in block 334, each user account may be processed in block 336. For each user in block 336, user specific settings for the software component may be set in block 338.

After each user is processed in block 336, the process may return to block 324 to process another software component.

In some embodiments, a user specific setting may not be defined. In the example of the word processing application and browser application described in embodiment 200, no user specific settings or permissions may be defined for those applications, meaning that all users may have the same access privileges or may be assigned default access privileges based on the local operating system.

In some operating systems, a user with local administrator privileges may have administrator privileges for any software on the local device. The local administrator privileges may allow the user to modify and configure the application locally. A normal user may have access privileges that allow the user to execute and use an application but may not permit the user to change the configuration or uninstall the application, for example.

If it is time for another update in block 340, the process may return to block 310. Otherwise, the process may hold at block 340.

Embodiment 300 is an example of a pull-type system where the client 302 requests updates from the server 304. Other embodiments may be a push-type system where the server 304 may transmit updates to the client 302 when the updates occur.

In a pull-type system as illustrated, the client 302 may periodically request an update. In some such embodiments, a predefined frequency of updates may be used. In order to minimize network congestion, some embodiments may have a predefined or random jitter applied to a predefined frequency. When jitter is included in the update frequency, the updates may occur at approximately the predefined interval, plus or minus the amount of jitter. Such systems may be useful when a large number of devices may be requesting updates over a single network and may be helpful in spreading out queries so as not to overload the server 304 or cause high bandwidth usage.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1.-20. (canceled)

21. A method comprising:
performing, by a client device, a query to a domain database, the domain database including user information for a plurality of domain users, the user information comprising domain level permissions for the domain users, and the domain database including descriptions of a plurality of software components;
receiving, by the client device, a subset of the descriptions of the plurality of software components;
determining, by the client device, a change in at least one description in the subset of the descriptions;
identifying, by the client device, a software component to install at the client device based on the change in the at least one description;
downloading, by the client device from a data store, an installation package associated with the software component; and
installing, by the client device, the software component using the installation package.

22. The method of claim 21, further comprising:
configuring the software component with a first set of settings for a first domain user; and
configuring the software component with a second set of settings for a second domain user.

23. The method of claim 21, further comprising:
filtering the descriptions of the plurality of software components to identify the subset of the descriptions of the plurality of software components.

24. The method of claim 21, wherein the change in the at least one description includes a change to a second software component.

25. The method of claim 24, wherein the change is associated with a first domain user but not with a second domain user.

26. The method of claim 21, wherein the query includes at a descriptor for the client device.

27. The method of claim 21, wherein the query includes a list of domain users having access to the client device.

28. The method of claim 21, wherein the domain database employs an LDAP protocol.

29. The method of claim 21, wherein the description includes parameters for the software components.

30. The method of claim 21, wherein the at least one of software components includes an executable file for a locally executable application.

31. The method of claim 21, wherein the description is an XML description.

32. A method comprising:
managing, by a server computing device, a database that includes permissions for a plurality of users, descriptions for each of a plurality of software components, and device information associated with a plurality of devices, wherein the device information indicates a subset of the plurality of software components and includes configuration settings for software components of the subset of software components;
receiving, by the server computing device, a query from a client device, wherein the client device is one of the plurality of devices;
selecting, by the server computing device, a software component from the subset of software components;
determining, by the server computing device, a download location comprising a location of a data store, the data store including an installation package for the software component;
determining, by the server computing device, a first configuration setting for the software component, the first configuration setting associated with a first user of the plurality of users;
determining, by the server computing device, a second configuration setting for the software component, the second configuration setting associated with a second user of the plurality of users; and
sending by the server computing device to the client device a set of descriptions, the set of descriptions including descriptions associated with software components of the subset of software components, the first configuration setting, the second configuration setting, and the download location.

33. The method of claim 32, wherein the query includes at least one descriptor for the client device.

34. The method of claim 32, wherein the query includes a list of domain users having access to the client device.

35. The method of claim 32, wherein the software component includes an executable file for a locally executable application.

36. A system comprising:
at least one memory and at least one processor, wherein the at least one memory and the at least one processor are respectively configured to store and execute instructions, including instructions for causing the system to:
query a domain database, the domain database including user information for a plurality of users, the user information comprising permissions for the users, and the domain database including descriptions of a plurality of software components;
receive at least some of the descriptions of the plurality of software components;
identify a software component to be installed at the client device based on the change in the at least one description;
download from a data store, an installation package associated with the identified software component; and
install the software component using the installation package.

37. The system of claim 36, wherein the at least one description includes a reference to a user, and the reference being associated with permissions for the user.

38. The system of claim 36, wherein the instructions are also for causing the system to:
configure the software component for a first user with a first set of settings; and
configure the software component for a second user with a second set of settings.

39. The system of claim 36, wherein the domain database also includes a set of device attributes for the system, and wherein the at least some descriptions are determined based on the set of device attribute.

40. The system of claim 36, wherein the query includes a list of users having an account on the system.
